(19) United States
(12) Patent Application Publication
(10) Pub. No.: US 2006/0219354 A1
(43) Pub. Date: Oct. 5, 2006

(54) Method for assembling elements of a structure comprising a honeycomb core

(75) Inventors: Claude Dehennau, Waterloo (BE); Dominique Grandjean, Brussels (BE)

Correspondence Address: CONNOLLY BOVE LODGE & HUTZ, LLP, P O BOX 2207, WILMINGTON, DE, 19899, US

(73) Assignee: Solvay S.A., Brussels (BE)

(21) Appl. No.: 10/564,877

(22) PCT Filed: Jul. 16, 2004
(86) PCT No.: PCT/EP04/51526

§ 371 Date: May 15, 2006

(30) Foreign Application Priority Data
Jul. 18, 2003 (FR) 03.08843

(51) Int. Cl. B32B 37/00

(52) U.S. Cl. 156/272.8

(57) ABSTRACT

Method of assembling the elements of a structure comprising a honeycomb core Method of assembling the elements of a structure comprising a cellular honeycomb core by welding using electromagnetic radiation, in which the structure is based on a plastic transparent to electromagnetic radiation, and at least one of the elements to be assembled comprises, in the vicinity of at least one part of its surface, a layer that at least partly absorbs the electromagnetic radiation, the welding taking place by the melting of this layer by means of the electromagnetic radiation in the weld zones.

The present invention relates to a method of assembling a plastic-based structure comprising a honeycomb core.

In many industries (the automobile industry, civil engineering, naval architecture, etc.), the aim is to optimize the mechanical properties/weight ratio of the structures used. Many methods have been developed to achieve this objective and one of the most common ones consists in using a honeycomb cellular structure sandwiched between two sheets called “skins”. By combining this technique with the choice of a lightweight material (a polymer rather than a metal), particularly lightweight structures may be obtained.

To be economically viable, these structures must be produced by simple and rapid processes, including the fewest possible steps and, from this standpoint, it is also judicious to choose polymers (and in particular thermoplastic polymers) as the constituent materials. This is because, owing to their thermoplasticity, these materials may be fashioned into a honeycomb structure in a single step, or at most two steps.

Thus, a process for manufacturing cellular structures by continuous extrusion has been proposed in Application FR 2 760 999, while Application WO 00/32382 describes a process for obtaining such structures by the thermoforming and folding of a preformed sheet. To assemble such structures, it is general practice to use either an adhesive (in WO 00/32382: both for bonding the honeycomb cells and for fastening the skins) or conventional welding methods (FR 2 760 999). However, these methods have the drawback of being slow and of requiring at least two steps: firstly the step of coating with the adhesive or preheating the elements to be welded, and then the assembly step. Furthermore, since in both cases the assembly step is carried out under a relatively high pressure, the cells of the honeycomb often collapse and/or become deformed.

The objective of the present invention is therefore to provide a method of assembling a plastic-based structure with a honeycomb core, which is rapid and causes the honeycomb cells neither to deform nor collapse.

For this purpose, the present invention relates to a method of assembling the elements of a structure comprising a honeycomb cellular core by welding using electromagnetic radiation, in which the structure is based on a plastic transparent to electromagnetic radiation and at least one of the elements to be assembled comprises, in the vicinity of at least one part of its surface, a layer that at least partly absorbs the electromagnetic radiation, the welding taking place by the melting of this layer by means of the electromagnetic radiation in the weld zones.

The method according to the invention ensures precise and rapid welding of the skins without honeycomb cells collapsing, since only the radiation-absorbent layer is melted. Furthermore, compared with the conventional welding methods (which generally involve heating a large part of the structure to a high temperature), it allows the use of uniaxially or biaxially oriented skins.

The term “honeycomb” is understood to mean a generally flat object (a sheet) comprising cells, which are open or closed and have any, but generally circular or hexagonal, cross section with walls that are essentially parallel from one cell to another.

The term “skins” is understood to mean sheets that are placed on either side of the surface of the honeycomb in order to close it off and thus produce sandwich panels. When uniaxially or biaxially oriented skins are welded to the honeycomb, it is observed that the radiation-absorbent layer partially surrounds the end of the adjacent vertical wall of the honeycomb and thus ensures better anchoring than that which would be obtained by conventional assembly techniques, such as adhesive bonding or thermal welding, and to do so without impairing the superior mechanical properties conferred by the orientation. The term “uniaxially or biaxially oriented skins” is understood to mean:
in the case of amorphous polymers (such as PVC, PET and PC), skins oriented at a temperature lying between the glass transition temperature +2° C. and the glass transition temperature +30° C.;
in the case of semicrystalline polymers (such as PA and POs), skins oriented at a temperature lying between the crystallization temperature −2° C. and the crystallization temperature −50° C.

According to the invention, the structure to be assembled is plastic-based. By this is meant that all the elements to be assembled are mainly plastic-based (that is to say they have a major weight fraction made of plastic, although this does not exclude the presence of inserts, reinforcements, etc. of any type).

Preferably, they are based on the same plastic or on a similar plastic (of the same type or compatible therewith) in order to encourage them to weld together.

The term “plastic” is understood to mean any thermoplastic polymer, including thermoplastic elastomers, and also blends thereof. The term “polymer” denotes both homopolymers and copolymers (especially binary or ternary copolymers). Examples of such copolymers are non-limitingly: random copolymers, linear or other block copolymers, and graft copolymers.

Any type of thermoplastic polymer or copolymer whose melting point is below the decomposition temperature is suitable. Synthetic thermoplastics that have a melting range spread over at least 10 degrees Celsius are particularly suitable. Examples of such materials include those that exhibit polydispersion in their molecular weight.

In particular, polyolefins, polyvinyl halides (PVC), thermoplastic polyesters, polyketones, polyamides and copolymers thereof may be used. Polyolefins (and in particular polypropylene (PP)) and PVC have given good results. A blend of polymers or copolymers may also be used, as may a blend of polymeric materials with various additives (stabilizers, plasticizers, inorganic, organic and/or natural or polymeric fillers, etc.). The plastic may also have undergone various treatments, such as expansion, orientation, etc. In the method according to the invention, it is important that the plastic be transparent to the electromagnetic radiation and so as to enable the radiation to be conveyed to the radiation-absorbent layer through the core of the elements to be assembled and to prevent too much plastic melting other than in the radiation-absorbent layer. According to the invention, the layer that at least partly absorbs the electromagnetic radiation is located in the vicinity of at least one part of the surface of at least one of the elements to be assembled and surrounds the weld zone(s).

The expression “in the vicinity of at least one part of the surface” is understood to mean that the layer is located either directly at the surface, at least on part of it, or directly below the surface, that is to say it is then located beneath a layer of material that may be of the same nature as the core of the element to be assembled, or is of a different nature (for example a protective layer). The first alternative, in which the layer is located directly on the surface, is preferred, and in this case measures are taken to ensure that the melting is targeted in this layer. In the second case, measures are taken in general to ensure that the surface layer lying on top of the absorbent layer is not too thick, as this also has to be melted in order to be able to form the weld.

The absorbent layer may be incorporated into the element to be welded by any suitable means: coextrusion, bonding, coating, etc. Coextrusion is an economic method, which generally gives good results. It should be noted that this layer may be continuous or discontinuous (for example consisting of bands that are present only in the regions to be welded). In general, it is preferable for this layer to be continuous, in order to simplify the manufacture.

In general, this layer is based on the same plastic as the element to be assembled, or on a similar plastic (having monomers that are of the same type and/or are compatible), but it contains additives that absorb the electromagnetic radiation.

The term “transparent” (which applies to the plastic as defined above) is understood to mean a plastic that absorbs an amount of energy of at most 100 T/g. of plastic, whereas the term “absorbent” is understood to mean that an amount of energy of at least 300 J/g of material is absorbed. This level of absorption may be achieved by using certain pigments such as carbon black, which generally gives good results.

According to a preferred way of implementing the method according to the invention, the electromagnetic radiation used has a wavelength of at least 700 nm. Likewise, it is preferred to use electromagnetic radiation whose wavelength is at most 1200 nm.

It is particularly preferable for the electromagnetic radiation to be infrared radiation. An IR source having a spectrum that is continuous over the entire emitted frequency range may be suitable, particularly sources that emit mainly in the range of wavelengths not absorbed by the plastic. Such IR sources are for example those having a very short wavelength, such as those that emit at around 1000 nm.

The best results have been obtained with coherent infrared radiation of the laser type. Examples of sources of such radiation are diode lasers and Nd:YAG (neodymium-doped yttrium aluminium garnet) lasers. It is preferably a diode laser given the relatively low-cost commercial availability of high-power lasers of this type.

According to the invention, the structure comprises several elements to be assembled, which may be parts of the honeycomb core (for example its cells), the skins located on either side of the core (perpendicular to its walls), as well as other elements such as one or more attachments, handles, reinforcements, etc.

If the honeycomb core is obtained by a process resulting in cells that are not welded (such as in certain variants of the process described in Application WO 00/32382 for example (the content of which is included by reference in the present application), the method according to the invention may be used to weld these cells. Thus, in a variant of the method according to the invention, the elements to be welded by means of the electromagnetic radiation consist partly of the cells of the core which was obtained by the thermoforming and folding of a plastic sheet and which includes the radiation-absorbent layer on both its faces.

As mentioned above, it is advantageous to provide both faces of a honeycomb with skins in order to increase the mechanical strength of the structure (especially in bending and in compression). The skins may therefore be fastened by the method described above. Consequently, in another advantageous variant of the method according to the invention, the elements to be welded by means of the electromagnetic radiation comprise two skins that are welded on either side of the core, perpendicular to the walls of the cells. Preferably, these skins are oriented and most particularly preferably they are biaxially oriented.

When the process for manufacturing the core is a continuous process, resulting in honeycombs of indefinite length, the assembly method according to the invention is advantageously implemented in line with the manufacture of the core.

Thus, for example when the core is obtained by a continuous extrusion process using an extruder followed by a cooling device (such as that described for example in Application FR 2 760 999, the content of which is also incorporated by reference in the present application), the method according to the present invention may be used to weld skins on either side of the core immediately after it leaves the cooling device. In this case, the said skins are provided on only one of their faces (near their surface) with a radiation-absorbent layer, the core and the skins themselves preferably being transparent to this radiation.

Likewise, the core is obtained by a process involving the thermoforming and folding of a sheet and possibly the assembling (by welding, bonding or any other appropriate technique) of the cells thus formed (as described for example in Application WO 00/32382), the method according to the present invention may be used to weld sheets on either side of the core immediately after it leaves the device for assembling the cells.

When this assembling operation also takes place by welding by means of electromagnetic radiation, and therefore when the core bears a radiation-absorbent layer, the skins do not even need to be provided with such a layer. Consequently, in a variant of the invention, the continuous process for manufacturing the core is a process involving the thermoforming and folding of a sheet that includes, on either side, the radiation-absorbent layer in order to form unwelded cells that will be assembled by welding using the electromagnetic radiation, and, in line with this welding operation, two skins containing no radiation-absorbent layer are fastened on either side of this core. The laser is positioned at an angle chosen according to the thickness of the core. The core/skin assembly is subjected to the electromagnetic radiation. All the welding consequently takes place in a single continuous operation which may optionally use more than one laser at a time, depending on the width to be welded.

Alternatively, the cells may either be assembled by adhesive bonding, or they may remain unwelded. Thus, in this variant of the invention, the continuous core manufacturing process is a process involving the thermoforming and folding of a sheet in order to form cells that either remain unwelded or are assembled by bonding using a solvent-free adhesive applied by coating the surface of the sheet in the zones to be bonded, and, in line with this bonding operation, two skins having a radiation-absorbent layer on only one of their faces are fastened on either side of the core. It will be preferable to choose a thixotropic adhesive having a high adhesive strength immediately on contact with the walls to be welded, in order to ensure overall integrity of the core.

The present invention is illustrated non-limitingly by the following examples:

### EXAMPLE 1

The following elements were assembled:
a honeycomb based on MOPLEN® 640P PP resin having cells of 8 mm×13 mm and a height of 20 mm, obtained by a continuous extrusion process according to Application FR 2 760 999; and
two skins with a thickness of 3 mm based on ELTEX® RF 110 PP resin having, on the surface, a coextruded layer based on RF 110 ELTEX® resin containing S phr of REMAFIN SCHWARZ® PAP carbon black, with a thickness of 50 μm, by means of a 40A (35W) CW FAP® COHERENT laser from Coherent Inc., with a collimated objective, of 810 nm wavelength and having a spectral band of around 3 nm.

A linear welding speed of 0.3 m/min (in steps of 5 mm) was achievable without any problem (correct welding, checked by examination on microtome sections).

Strength tests in 3-point bending were carried out on a specimen taken from the welded structure, with a distance between supports of 210 mm. The crossbeam speed was 20 mm/min and the loads measured at the various displacements were:

| Displacement (mm) | Load (N) |
|---|---|
| 1 | 99.4 |
| 2 | 201 |
| 3 | 300 |

The maximum displacement measured was 17 mm for a load of 966 N, which amounts to a strain of 5%.

### EXAMPLE 2

The following elements were assembled:
a honeycomb based on rigid PVC resin having regular hexagonal cells with sides of 3 mm and a height of 8 mm, obtained by a process according to Application WO 00/32382 involving the thermoforming and folding of a 150 μm thick sheet; and
two skins with a thickness of 2 mm, based on uniaxially oriented rigid PVC (267RB resin from Solvin) having, on the surface, a coextruded layer based on the same formulation containing 4 phr of carbon black, with a thickness of 50 μm,
   by means of a 40A (35W) CW FAP® COHERENT laser from Coherent Inc., with a collimated objective, of 810 nm wavelength and having a spectral band of around 3 nm.

A linear welding speed of 1.5 m/min (in steps of 5 mm) was achievable without any problem.

Strength tests in 3-point bending were carried out on a specimen taken from the welded structure, with a distance between supports of 150 mm. The crossbeam speed was 2 mm/min and the loads measured at the various displacements were:

| Displacement (mm) | Load (N) |
|---|---|
| 1 | 136 |
| 2 | 267 |
| 3 | 386 |

The maximum displacement measured was 5.2 mm for a load of 511 N, which amounts to a strain of 1.7%.

1-8. (canceled)

9. A method of assembling the elements of a structure based on a plastic transparent to laser radiation, comprising a cellular honeycomb core and two skins on either side of the core, perpendicular to the walls of the cells, in which at least one of the skins and the core are assembled by welding using laser radiation, and at least one of the elements to be assembled comprises, in the vicinity of at least one part of its surface, a layer that at least partly absorbs the laser radiation, the welding taking place by the melting of this layer by means of the laser radiation in the weld zones.

10. The method according to claim 9, wherein the plastic is a PP or a PVC.

11. The method according to claim 9, wherein the elements to be welded by means of the laser radiation further include the cells of the core and wherein the latter is obtained by the thermoforming and folding of a plastic sheet, the laser-radiation-absorbent layer of which is located on either side of this sheet.

12. The method according claim 9, wherein the core is obtained by a continuous manufacturing process and wherein the welding of the skins by means of the laser radiation takes place in line with this manufacturing process.

13. The method according claim 12, wherein the continuous process for manufacturing the core is an extrusion process and wherein the laser-radiation-absorbent layer is located on only one face of each of the two skins.

14. The method according to claim 12, wherein the continuous process for manufacturing the core is a process involving the thermoforming and folding of a sheet that includes, on either side, the laser-radiation-absorbent layer in order to form unwelded cells; wherein the unwelded cells are assembled by welding using the laser radiation and wherein the two skins do not contain the radiation-absorbent layer.

15. The method according to claim 12, wherein the continuous process for manufacturing the core is a process involving the thermoforming and folding of a sheet in order to form unwelded cells; wherein the cells remain unwelded but are optionally assembled by bonding using a solvent-free adhesive applied by coating the surface of the sheet in the zones to be bonded and wherein the laser-radiation-absorbent layer is located on only one face of each of the two skins.

16. The method according claim 9, wherein the skins are uniaxially or biaxially oriented.
